(19) United States
(12) Patent Application Publication
(10) Pub. No.: US 2010/0200710 A1
(43) Pub. Date: Aug. 12, 2010

(54) COMPACT CAMERA STAND

(76) Inventor: MATTHEW SHENOUDA, Glendale, CA (US)

Correspondence Address: LAW OFFICE OF JERRY D. HAYNES , P.A, P.O. Box 350392, Fort Lauderdale, FL, 33335, US

(21) Appl. No.: 12/370,410

(22) Filed: Feb. 12, 2009

(51) Int. Cl. F16M 11/00

(52) U.S. Cl. 248/157

(57) ABSTRACT

The present invention relates to a monopod camera support device that provides a means to attach a camera for photography purposes. The present invention includes a cylindrical base that functions as an enclosure for a telescoping extension when the support is in a closed position. When the support is in an open position, the telescoping extension is extended with a mounting bracket at the opposite end of the telescoping extension. The mounting bracket provides a means for the attachment of a camera thereto which may be specifically attached to a screw under one exemplary embodiment. The mounting bracket also includes a release that enables the bracket to swivel and to be locked into a desired position.

### BACKGROUND OF THE INVENTION

1. Field of Invention

The present invention relates to camera supporting devices wherein the user is able to securely mount a camera for photography.

2. Description of Related Art

The field of photography is a dynamic area that has grown and evolved through the years. Various types of cameras are available for use by the consumer including film, digital, digital video and the recently popular camera phone. Many consumers however use conventional hand-held cameras, either digital or film. On certain instances it is advantageous for the photographer to mount his camera on a support device in order to capture a picture. Usually the support device is necessary to improve the overall picture quality and reduce any vibration that may be associated with holding the camera with one's hand. Another instance where a photographer may use a stand is when the photographer desires to take a self-portrait.

The prior art discloses various camera stands and supporting devices. U.S. Pat. No. 3,870,264 ('264 patent hereinafter) discloses a conventional camera stand with a retractable leg assembly. The '264 patent includes an upright member with a telescopic retracting feature. The '264 patent discloses a camera stand with a retracting member that's supported on a three-legged assembly.

U.S. Pat. No. 6,244,759 ('759 patent hereinafter) discloses an adjustable camera support that includes a lower pistol grip. The adjustable camera support disclosed in the '759 patent includes a clamp that secures the supporting gooseneck of the camera support. The gooseneck is extendable and the mounting tip of the camera support is rotatable 180 degrees vertically and 360 degrees horizontally. The '759 patent requires a supporting device to clamp the camera support in order to mount the support in a secure manner.

U.S. Pat. No. 6,439,515 ('515 patent hereafter) discloses a video camera support with a four-wheel supporting base. The four-wheel supporting base provides for a stationary and mobile camera support. A drawback to the '515 patent includes the use of multiple components and a complex assembly procedure.

U.S. Pat. No. D347501 ('501 patent hereinafter) discloses a expandable supporting pedestal for a camera. As depicted in the multiple views of the '501 patent, the support pedestal involves a small pedestal that apparently is suitable for a tabletop collapsible support for a camera. The '501 patent fails to have a great deal of flexibility in use due to apparent limitations.

Although the prior art provides an assortment of camera-supporting pedestals many require a supporting base similar to the conventional tripod or perhaps wheels for mobility. Further the supporting pedestals that don't require a tripod assembly as a base are small and have limited parameters of use. It consequently would be advantageous to have a flexible camera pedestal that is lightweight, easy to use and very portable in nature.

### SUMMARY OF THE INVENTION

The present invention provides a novel camera support device comprising: a cylindrical base; a telescoping extension protruding from the cylindrical base; a mounting bracket attached to a distal end of the telescoping extension wherein the distal end is opposite to the cylindrical base; and a means to attach a camera to the mounting bracket. The camera support device may also include a swivel bracket within said mounting bracket and where the means to attach includes a mounting screw. The mounting screw may extend from the swivel bracket in order to receive the camera.

Other features of the camera support device may include a release lock for the swivel bracket. The swivel bracket rotates about an axis when the release lock is in an open position and swivel bracket remains stationary when the release lock is in a closed position. The camera support device according to the present invention may also include an interchangeable screw that attaches the telescopic extension to the cylindrical base. In fact the telescoping extension may be stored within the cylindrical base when in a closed position and the cylindrical base may include a handgrip enabling the present invention to be used as a handheld device.

### BRIEF DESCRIPTION OF DRAWINGS

FIG. 1 depicts a novel camera pedestal according to the present invention.

### DETAILED DESCRIPTION OF THE INVENTION

The present invention relates to a monopod camera support pedestal that provides a camera pedestal supported by a firm base. Contrary to the prior art, the present invention provides a collapsible camera support that is stored in a cylindrical base.

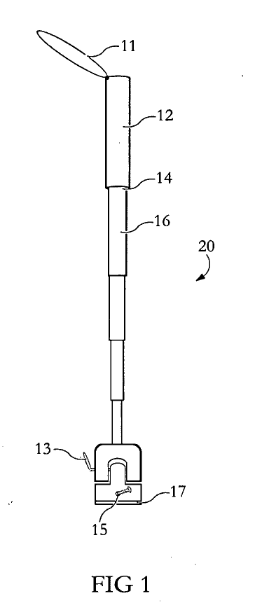

FIG. 1 depicts a monopod camera support 20 according to the present invention. The monopod support 20 includes a cylindrical base 12. The cylindrical base 12 functions as an enclosure for a telescoping extension 16 when the support 20 is in a closed position. FIG. 1 shows the support 20 in an open position where the telescoping extension 16 is extended with a mounting bracket 18 at the opposite end of the telescoping extension 16. The mounting bracket 18 provides a means for the attachment of a camera thereto which is specifically attached to a screw 15. The mounting bracket 18 also includes a release 13 that enables the bracket to swivel and to be locked into a desired position. A pad 17 is also provided on the mounting device as a means to protect the camera from damage during use.

In one exemplary embodiment, the monopod camera support 20 is used as a hand-held device. A camera is mounted to the mounting bracket 18 and enables the photographer to direct the camera at his desired subject of his photograph. One example photograph suitable for using the monopod support 20 includes a self-portrait. The cylindrical base 12 includes a handgrip and enables the photographer to grip the support while the camera is placed on the mounting bracket 18. A photographer also may place the base 12 on the ground or floor and then stand the support 20 in an upright position. In this manner photographs may be taken while the support 20 is in a standing position.

An additional feature of the support 20 is the strap 11 that extends from the opposite or distal end of the cylindrical base 12. An interchangeable screwing mount 14 exists at the telescoping end of the cylindrical base 12. This interchangeable screw 14 enables the photographer to release the telescoping extension 16 from the base 12. Once released from the base 12, the base 12 includes a hollow interior and provides a storage area for additional accessories that the photographer may need such as rolls of film or batteries.

The monopod 20 may be conveniently carried in an individual's pocket or bag when it's in its closed position. Further a separate specialty designed bag may be provided for the monopod 20 in order to enclose the monopod 20 and other camera accessories.

The monopod 20 therefore provides a unique and novel camera support device that is collapsible and convenient to use. The tubing may extend up to 2½ to 3 feet in length, however smaller versions of the monopod support 20 may be suitable in certain instances. The monopod 20 provides the photographer several options and capabilities to improve photographic experience. Contrary to the disclosed prior art the monopod 20 is easy to use and is not cumbersome in any manner in transport or assembly. The monopod 20 also enables the photographer to capture pictures at various angles that he may not be able to achieve without the use of this unique camera support system.

The monopod support 20 may be made of various materials such as metal, i.e., aluminum, stainless steel or carbon composites. The monopod support 20 may also be manufactured of plastic materials in certain instances to provide a lighter version thereof. Regardless of the material used to construct the monopod 20, the overall structure would be consistent as described above.

What is claimed is:

1. A camera support device comprising:
a. a cylindrical base;
b. a telescoping extension protruding from the cylindrical base;
c. a mounting bracket attached to a distal end of the telescoping extension wherein the distal end is opposite to the cylindrical base; and
d. a means to attach a camera to the mounting bracket.

2. The camera support device according to claim 1, further comprising a swivel bracket within said mounting bracket, wherein said means to attach include a mounting screw where said mounting screw extends from said swivel bracket.

3. The camera support device according to the claim 2, further comprising a release lock for said swivel bracket.

4. The camera support device according to claim 3, wherein said swivel bracket rotates about an axis when release lock is in an open position and swivel bracket remains stationary when said release lock is in a closed position.

5. The camera support device according to claim 4, further comprising an interchangeable screw that attaches the telescopic extension to the cylindrical base.

6. The camera support device according to claim 1, wherein in the telescoping extension is stored within the cylindrical base when in a closed position.

7. The camera support device according to claim 1, wherein cylindrical base includes a handgrip and said camera support device is handheld.

8. A method of mounting a camera comprising the steps of:
a. extending a telescopic extension from a cylindrical base;
b. attaching a camera to a mounting bracket where said mounting bracket is attached to the distal end of the telescopic extension; and
c. locking the attached camera to a suitable position for the desired photograph.
